(19) United States
(12) Patent Application Publication
(10) Pub. No.: US 2020/0212999 A1
(43) Pub. Date: Jul. 2, 2020

(54) SATELLITE COMMUNICATION APPARATUS

(71) Applicants: KABUSHIKI KAISHA TOSHIBA, Minato-ku (JP); Toshiba Infrastructure Systems & Solutions Corporation, Kawasaki-shi (JP)

(72) Inventor: Takeshi KATAGI, Oyama (JP)

(73) Assignees: KABUSHIKI KAISHA TOSHIBA, Minato-ku (JP); Toshiba Infrastructure Systems & Solutions Corporation, Kawasaki-shi (JP)

(21) Appl. No.: 16/548,188

(22) Filed: Aug. 22, 2019

(30) Foreign Application Priority Data
Dec. 26, 2018 (JP) 2018-242489

(51) Int. Cl. H04B 7/185; H01Q 3/04

(52) U.S. Cl. CPC H04B 7/18519; H04B 7/18528; H01Q 3/04; H04B 7/18515

(57) ABSTRACT

According to one embodiment, a satellite communication apparatus includes a first unit including a power supply unit configured to supply a power source and a first motor configured to rotate a supporting column in a horizontal direction, a motor unit including a second motor configured to control an elevation angle of the supporting column with respect to the first unit, and a second unit supported by the supporting column and including a third motor configured to adjust a polarization angle of an antenna, a magnetic sensor arranged to be less susceptible to a magnetic field of the third motor, and a control device to control the first motor or the second motor before calibration of the magnetic sensor.

### CROSS-REFERENCE TO RELATED APPLICATIONS

This application is based upon and claims the benefit of priority from Japanese Patent Application No. 2018-242489, filed Dec. 26, 2018, the entire contents of which are incorporated herein by reference.

### FIELD

Embodiments described herein relate generally to a satellite communication apparatus.

### BACKGROUND

A satellite communication apparatus such as the very small aperture terminal (VSAT) for communicating with a satellite is known.

a satellite communication apparatus requires information on its azimuth (or the azimuth of a satellite to the satellite communication apparatus) to achieve communication with the satellite. If the azimuth is not known during automatic acquire of a satellite, the satellite can be captured by rotating the satellite communication apparatus 360 degrees; however, this requires considerable time.

Generally, a sensor used for finding the azimuth is a magnetic sensor. Magnetic sensor cannot be used at places affected by a magnetic field of metals, etc.; however, an automatic capture apparatus for the satellite communication apparatus involves components which can generate magnetic fields, such as a power supply unit or motors.

In order to ascertain the azimuth of the satellite communication apparatus itself, the magnetic sensor must be used; however, as mentioned above, the automatic capture apparatus for the satellite communication apparatus includes power supply units, motors, etc. that can generate magnetic fields, and it may require time to capture the satellite depending on the orientation of the installed satellite communication apparatus due to the influence of the magnetic field.

### BRIEF DESCRIPTION OF THE DRAWINGS

FIG. 1 is a side view of a satellite communication apparatus C of a first embodiment;

FIG. 2 is a diagram showing components arranged in a platform unit 2 according to the first embodiment;

FIG. 3 is a diagram showing components arranged in the control unit 4 according to the first embodiment;

FIG. 4 is a diagram showing the state before the rotation of control unit 4 in the horizontal direction, on a platform unit 2, according to the first embodiment;

FIG. 5 is a diagram showing the rotation of the control unit 4 in the horizontal direction on the platform unit 2 according to the first embodiment;

FIG. 6 is a flowchart to show the first operation example for explaining the operation of the satellite communication apparatus C according to the first embodiment;

FIG. 7 is a side view of a satellite communication apparatus C of a second embodiment;

FIG. 8 is a diagram showing components arranged in a platform unit 2 according to the second embodiment;

FIG. 9 is a diagram showing the state before the rotation of a control unit 4 in the horizontal direction on a platform unit 2 according to the second embodiment;

FIG. 10 is a diagram showing the rotation of control unit 4 in the horizontal direction on the platform unit 2 according to the second embodiment; and

FIG. 11 is a flowchart to show the second operation example for explaining the operation of the satellite communication apparatus C according to the second embodiment.

### DETAILED DESCRIPTION

In general, according to one embodiment, there is provided a satellite communication apparatus for communication through a satellite. The satellite communication apparatus includes a first unit including power supply units configured to supply power sources and a first motor configured to rotate a supporting column in a horizontal direction; a motor unit including a second motor configured to control an elevation angle of the supporting column with respect to the first unit; and a second unit supported by the supporting column and including a third motor configured to adjust a polarization angle of an antenna, a magnetic sensor arranged to be less susceptible to a magnetic field of the third motor, and a control device configured to control the first motor or the second motor before calibration of the magnetic sensor.

Hereinafter, the present embodiments will be described in detail with reference to the accompanying drawings. In the description below, elements having the same functions and configurations will be denoted by the same reference symbols and repetitive explanation will be only made when necessary. Each of the following embodiments is an example of the apparatus or method for implementing a technical idea of the present embodiment, and the technical idea does not limit the material, shape, structure, and arrangement etc. of the components to the following items. Various changes can be made to the technical idea of the present embodiment within the scope of the claims.

Each function block can be implemented as either hardware or computer software or a combination thereof. Thus, to clarify this, the description of each block will be given generally from the functional perspective. Whether such function is executed as hardware or software depends on the concrete form of implementation or design constraints imposed on the entire system. A person with ordinary skill in the art would be able to achieve such functions through various methods, but to decide on such achievements is within the scope of the present disclosure.

### First Embodiment

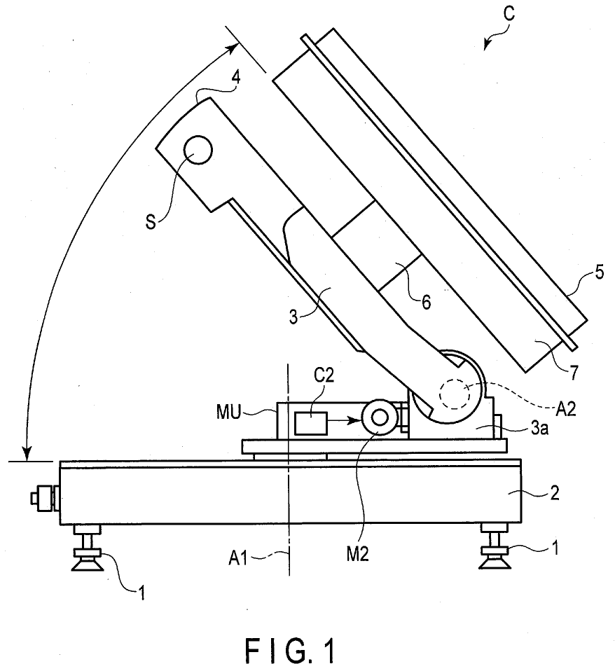

First, a first embodiment will be described in reference to FIGS. 1 to 6. The first embodiment is an embodiment where a rotation axis A1 of a platform unit 2 and a control unit 4 is positioned at the approximate center of the platform unit 2, when a satellite communication apparatus C is viewed from above.

FIG. 1 is a side view of the satellite communication apparatus C of the embodiment.

As shown in FIG. 1, the satellite communication apparatus C of the embodiment includes the platform unit 2 (first unit) supported by a support leg 1. The platform unit 2 is a rectangular shape unit, and a supporting column attachment unit 3a is provided on an upper surface. This supporting column attachment unit 3a is attached to one end side of a supporting column 3.

An upper surface of the platform unit 2 is provided with a motor unit MU. A motor M2 (second motor) is provided in an inner side of the motor unit MU, and a controller C2 for controlling the motor M2 is provided on the platform unit 2. The controller C2 functions as an elevation angle controller for controlling an elevation angle (EL angle) of the supporting column 3 around another rotation axis A2, with respect to the upper surface of the platform unit 2, by controlling the motor M2 based on the instruction from a control device 21 of the control unit 4 (refer to FIG. 3).

The supporting column 3 supports the side surface of the control unit 4 (second unit) from both ends. Accordingly, the motor M2 adjusts the elevation angle of an antenna 5 attached to the control unit 4. The motor unit MU may be provided on an inner side of the supporting column 3.

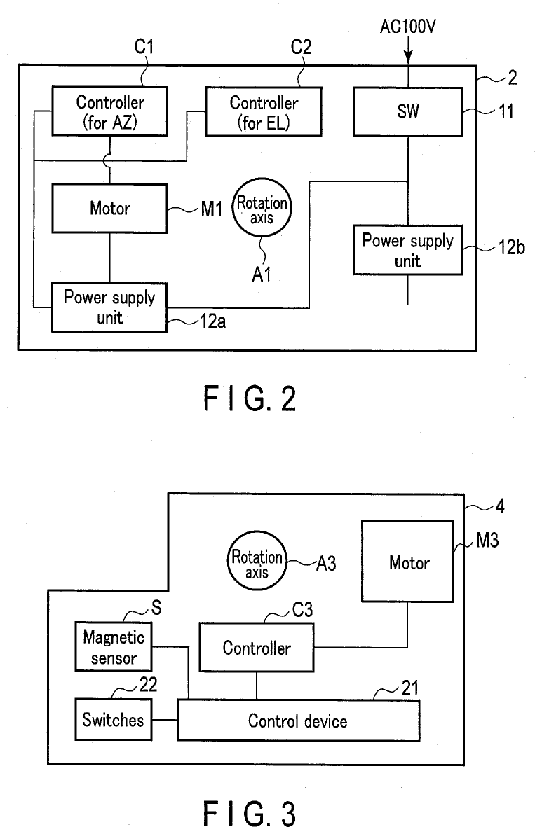

The supporting column 3 is rotatable in the horizontal direction around the rotation axis A1 by a motor M1 (first motor: refer to FIG. 2) of the platform unit 2.

A magnetic sensor S is provided in an inner side of the control unit 4. The upper surface of the control unit 4 is provided with an operation device 6 for adjusting a polarization angle (POL angle) of the antenna 5, and the antenna 5 itself via a transmission/reception processing device 7 for processing transmission/reception signals of the antenna 5. The antenna 5, operation device 6 and transmission/reception processing device 7 constitute an antenna device.

The operation device 6 adjusts the polarization angle of the antenna 5 via a motor M3 (third motor: refer to FIG. 3) of the control unit 4. The transmission/reception processing device 7 performs processing of the reception signals received at the antenna 5, and transmits the data obtained by the signal processing to the control device 21 of the control unit 4.

FIG. 2 is a diagram showing the components arranged in the platform unit 2 according to the first embodiment.

As shown in FIG. 2, the platform unit 2 includes a switch (SW) 11, power supply units 12a and 12b, controllers C1 and C2, and the motor M1. The motor M1 and power supply units 12a, 12b are parts generating a magnetic field which affects calibration of the magnetic sensor S; in particular, the power supply units 12a and 12b generate a strong magnetic field that affects the calibration of the magnetic sensor S.

In the embodiment, the power supply units 12a and 12b are arranged in the platform unit 2, and the magnetic sensor S is arranged in the control unit 4, so that the magnetic sensor S is less susceptible to the magnetic field of the power supply units 12a and 12b.

The AC voltage (for example, AC 100V) supplied from the exterior of the platform unit 2 through the switch 11 is supplied to each of the power supply units 12a and 12b.

The power supply unit 12a (first power supply unit) converts AC voltage to DC voltage; the DC voltage being supplied to the controllers C1 and C2 of the platform unit 2 before then being supplied to the motors M1 and M2 from the controllers.

The power supply unit 12b (second power supply unit) converts AC voltage to DC voltage and supplies the DC voltage to components such as the control unit 4, operating device 6 and transmission/reception processing device 7. More specifically, in the embodiment, for each component such as the control unit 4, not only the power supply unit 12a but also the power supply unit 12b, is arranged in the platform unit 2.

The controller C1 controls the motor M1 based on the instruction from the control device 21 of the control unit 4, and rotates the supporting column 3 in the horizontal direction around the rotation axis A1 with respect to the platform unit 2, therefore functioning as an azimuth angle controller. In other words, the motor M1 adjusts the azimuth angle (AZ angle) of the antenna 5.

The rotation axis A1 is provided at a position almost central in the horizontal direction of the platform unit 2.

FIG. 3 is a diagram showing components arranged in the control unit 4 according to the first embodiment.

As shown in FIG. 3, the control unit 4 includes the magnetic sensor S, the control device 21, switches 22, a controller C3 and a motor M3, which are necessary for the control unit 4 to perform calibration. Both side surfaces of the control unit 4 are supported by the supporting column 3. The controller C2 controls the motor M2 to move the supporting column 3 in the elevation angle direction around the rotation axis A2, so as to control the elevation angle of the supporting column 3.

The switches 22 includes a acquire button, an operation button and a storage button. The acquire button is a button for starting the capture process. The operation button is a button for commencing communication after an automatic capture apparatus turns the antenna in a desired satellite direction. The storage button is a button for storing the deployed automatic capture apparatus.

When the acquire button is operated after the power is inputted, the calibration process of the magnetic sensor S is executed before the satellite capture process for capturing the satellite. This calibration process is not limited to processing before the satellite capture process, and may be executed at any timing. The calibration process of the magnetic sensor S and the satellite capture process may adopt a publically known technique, details of which shall not be described.

The control device 21 of the control unit 4 takes total control over the satellite communication apparatus C, such as controls according to the embodiment, the aforementioned satellite capture process and calibration process, and so on.

The controller C3 controls the motor M3 based on the instruction from the control device 21 of the control unit 4 and adjusts, via the operation device 6, the polarization angle of the antenna 5 around the rotation axis A3 which is the center of the antenna 5.

The magnetic sensor S acquires azimuth information of the satellite communication apparatus C by detecting the magnetic field.

As shown in FIG. 3, the motor M3 exists inside the control unit 4; thus, the magnetic sensor S is arranged further away from the motor M3 so as to avoid the influence of the magnetic field from the motor M3. In the embodiment, the motor M3 is arranged at a position further away from the magnetic sensor S than the control device 21 and controller C3.

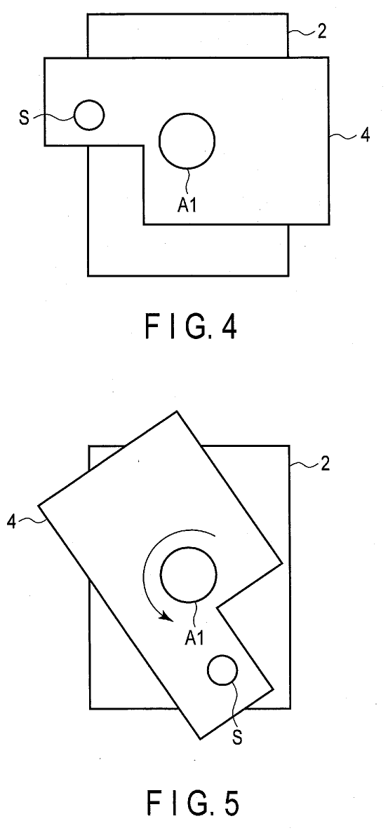

FIG. 4 is a diagram showing the state of the control unit 4 of the first embodiment after raising the control unit 4 on the platform unit 2 in the vertical direction, and before rotating it in the horizontal direction.

FIG. 5 is a diagram where, after raising the control unit 4 on the platform unit 2 in the vertical direction, the control unit 4 in the first embodiment is rotated in the horizontal direction. As shown in FIGS. 4 and 5, the control unit 4 executes the calibration process after being raised in the vertical direction and rotated in the horizontal direction.

According to the embodiment, the satellite communication apparatus C with the magnetic sensor S, which foresees the influence of the magnetic field, operates as follows.

When it is determined that the satellite communication apparatus C of the embodiment is being affected by the magnetic field, the satellite communication apparatus C executes the following process. When it is determined not to be affected by the magnetic field, the following operation is not performed and the process of a second embodiment will be performed.

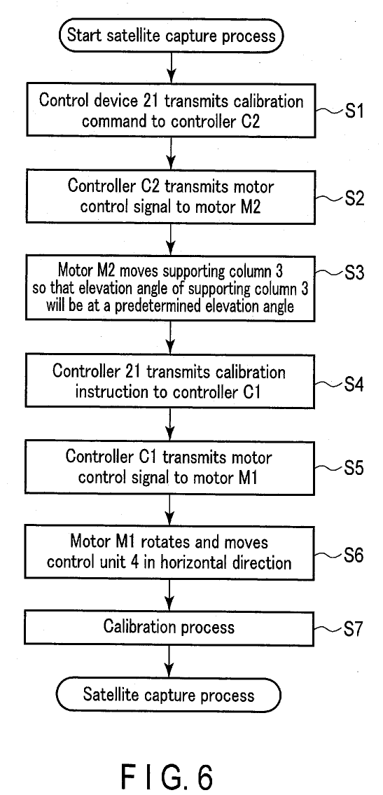

FIG. 6 is a flowchart for showing the first operation example for explaining the operation of the satellite communication apparatus C according to the first embodiment.

When the power of the control device 21 of the control unit 4 is turned on, and it is detected that the acquire button is operated, the satellite communication apparatus C performs the following process as a preprocessing for starting the satellite capture process.

As shown in FIG. 6, as a preprocessing for stating the satellite capture process, the control device 21 of the control unit 4 outputs a calibration command to the controller C2 of the motor unit MU provided on the upper surface of the platform unit 2 (S1).

The controller C2 receives the calibration command and transmits a motor control signal to the motor M2 (S2). Upon receipt of the control signal from the controller C2, the motor M2 moves the supporting column 3 so that the elevation angle of the supporting column 3 will be at a predetermined angle (for example, 45 degrees) (S3). With the movement of the supporting column 3, the control unit 4, supported by the supporting column 3, is also moved.

The control device 21 of the control unit 4 then outputs the calibration command to the controller Cl of the platform unit 2 (S4).

The controller C1 receives the calibration command and transmits a motor control signal to the motor M1 (S5).

When the control signal from the controller C1 is received, the motor M1 rotates the supporting column 3 and the control unit 4 around the rotation axis A1 in the horizontal direction at a predetermined angle with respect to the platform unit 2 (S6). In an exemplary instance of the rotation in the horizontal direction, the magnetic field strength is measured at two angles with an angle difference of 180 degrees.

Courtesy of the control unit 4, the calibration process of the magnetic sensor S is performed (S7), and the satellite communication apparatus C enters the satellite capture process.

As a result, the magnetic sensor S, disposed in the control unit 4, moves away from the platform unit 2. The magnetic sensor S is now less susceptible to the magnetic field from the first power supply unit 12a, second power supply unit 12b and motor M1 in the platform unit 2.

### Second Embodiment

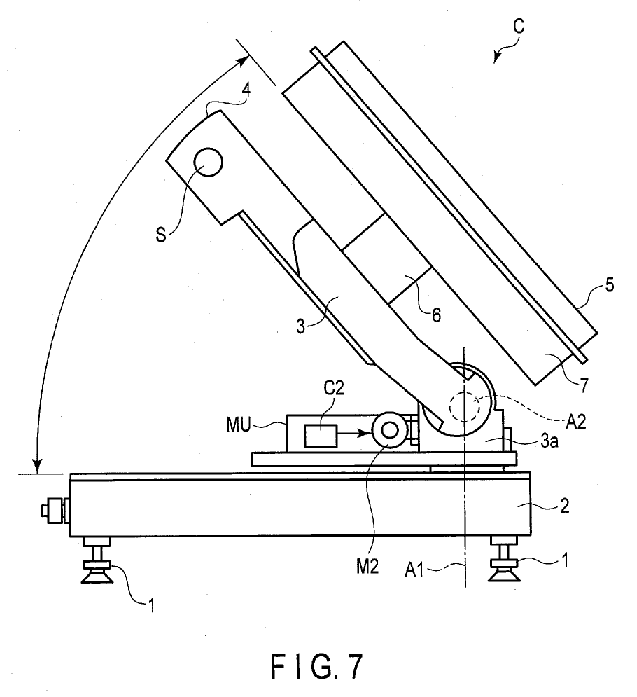

Next, a second embodiment will be described in reference to FIGS. 7 to 11. Differently to the first embodiment, the second embodiment sees a rotation axis A1 of a platform unit 2, and a control unit 4, positioned off the approximate center of the platform unit 2 when a satellite communication apparatus C is viewed from above.

FIG. 7 is a side view of a satellite communication apparatus C of the second embodiment. The difference from FIG. 1 is that the rotation axis A1 is arranged at a position different to the horizontal center of the platform unit 2.

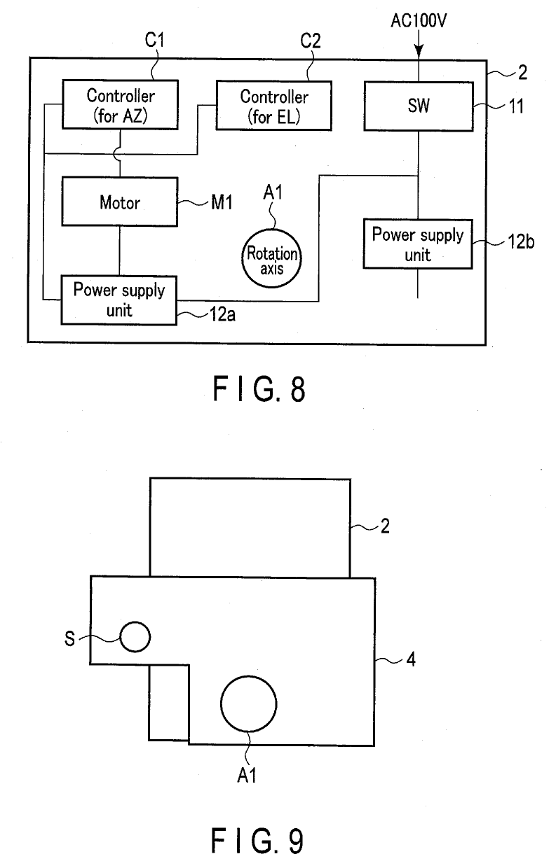

FIG. 8 is a diagram showing components arranged in a platform unit 2 according to the second embodiment. The difference from FIG. 2 is that the rotation axis A1 is arranged at a position that is not at the center of the platform unit 2 and the control unit 4 when the satellite communication apparatus C is viewed from above. Note that the control unit 4 of the second embodiment is similar to FIG. 3.

FIG. 9 is a diagram showing the state before the rotation of the control unit 4 in the horizontal direction on the platform unit 2 according to the second embodiment.

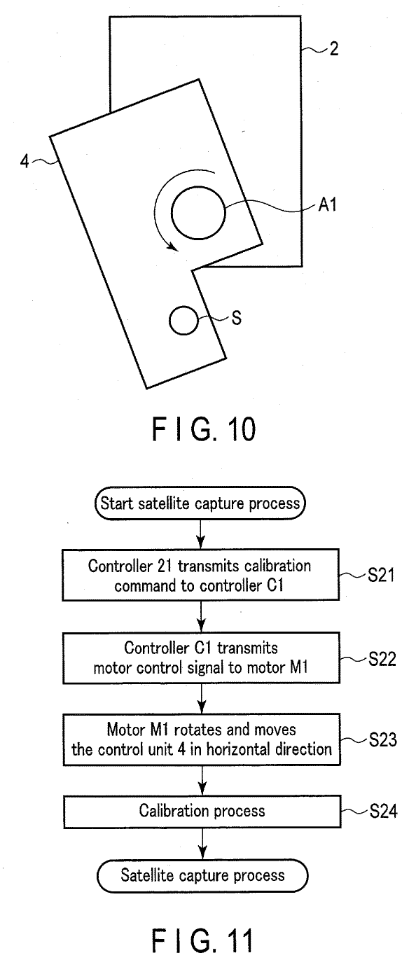

FIG. 10 is a diagram showing the control unit 4 rotated in the horizontal direction on the platform unit 2 according to the second embodiment. As shown in FIGS. 9 and 10, by arranging the rotation axis A1 to a position that is not at the center of the platform unit 2 and the control unit 4, the magnetic sensor S can be arranged further away from the platform unit 2.

FIG. 11 is a flowchart which shows the second operation example for explaining the operation of the satellite communication apparatus C of the embodiment.

As shown in FIG. 11, as a preprocessing for starting the satellite capture process, the control device 21 of the control unit 4 outputs a calibration command to the controller C1 of the platform unit 2 (S21).

The controller C1 receives the calibration command and transmits a motor control signal to the motor M1 (S22).

When the control signal from the controller C1 is received, the motor M1 rotates the supporting column 3 and the control unit 4 around the rotation axis A1 in the horizontal direction at a predetermined angle with respect to the platform unit 2 (S23).

As a result, the magnetic sensor S, disposed in the control unit 4, moves away from the platform unit 2. The magnetic sensor S is now less susceptible to the magnetic field from the first power supply unit 12a, second power supply unit 12b and motor M1 in the platform unit 2.

Courtesy of the control unit 4, the calibration process of the magnetic sensor S is performed (S24), and the satellite communication apparatus C enters the satellite capture process.

Thus, the influence of the magnetic field to the magnetic sensor S from the motor M1, and power supply units 12a and 12b of the platform unit 2, can be reduced. By allowing the calibration process to be performed in a state where the influence of the magnetic field to the magnetic sensor S is reduced, the azimuth of the satellite communication apparatus C can be correctly specified.

Therefore, according to the satellite communication apparatus C of the embodiment, by providing the magnetic sensor S in the control unit 4 rather than in the platform unit 2, the influence of the magnetic field from the motor M1 and power supply units 12a, 12b of the platform unit 2 can be reduced.

Further, in the control unit 4, the magnetic field is generated from the motor M3 for adjusting the polarization angle of the antenna 5; however, by arranging the magnetic sensor S at a position that is less susceptible to the influence of the magnetic field, the influence of the magnetic field can be further reduced.

When the magnetic sensor S is provided in the control unit 4 and at a position less susceptible to the influence of the magnetic field from the motor M3, and if the magnetic sensor S is still susceptible to the magnetic field from the motor M1 and power supply units 12a and 12b, it is possible to reduce the influence of the magnetic field by controlling the elevation angle of the control unit 4 with respect to the platform unit 2, or by rotating the control unit 4 in the horizontal direction relative to the platform unit 2. By performing the calibration process in the resulting state, the azimuth of the satellite communication apparatus C can be quickly specified.

As explained in the detail above, the embodiments can provide a satellite communication apparatus capable of preventing the instance of time lost on capturing a satellite due to the effect of the magnetic field.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made. The accompanying claims and their equivalents are intended to cover such forms or modifications as would fall within the scope of the inventions.

1. A satellite communication apparatus for communication through a satellite, the satellite communication apparatus comprising:
a first unit including a power supply unit configured to supply a power source and a first motor configured to rotate a supporting column in a horizontal direction;
a motor unit including a second motor configured to control an elevation angle of the supporting column with respect to the first unit; and
a second unit supported by the supporting column and including a third motor configured to adjust a polarization angle of an antenna, a magnetic sensor arranged to be less susceptible to a magnetic field of the third motor, and a control device configured to control the first motor or the second motor before calibration of the magnetic sensor.

2. The satellite communication apparatus according to claim 1, wherein the magnetic sensor is arranged at a position away from the third motor in the second unit.

3. The satellite communication apparatus according to claim 1, wherein a rotation axis of the first unit and the second unit is at an approximate horizontal center of the first unit.

4. The satellite communication apparatus according to claim 3, wherein the first unit further includes:
an elevation angle controller configured to control the second motor to move the supporting column, based on a satellite capture command from the control device, so that the elevation angle of the supporting column is set at a predetermined angle and the magnetic sensor is away from the first unit and less susceptible to a magnetic field from the first unit, and
an azimuth angle controller configured to control the first motor to horizontally rotate the supporting column and the second unit relative to the first unit, based on the satellite capture command from the control device, so that the magnetic sensor is away from the first unit and less susceptible to the magnetic field from the first unit.

5. The satellite communication apparatus according to claim 1, wherein a rotation axis of the first unit and the second unit is at a position which differs from a horizontal center of the first unit.

6. The satellite communication apparatus according to claim 5, wherein the first unit further includes:
a controller configured to control the first motor to horizontally rotate the supporting column, and the second unit relative to the first unit, based on the satellite capture command from the control device, so that the magnetic sensor is away from the first unit and less susceptible to the magnetic field from the first unit.
